(19) United States
(12) Patent Application Publication
(10) Pub. No.: US 2012/0268863 A1
(43) Pub. Date: Oct. 25, 2012

(54) ELECTROLYTIC CAPACITOR

(75) Inventor: Michael Toni LIPNIG, Klagenfurt (AT)

(73) Assignee: VISHAY BCCOMPONENTS AUSTRIA GMBH, Klagenfurt (AT)

(21) Appl. No.: 13/090,571

(22) Filed: Apr. 20, 2011

(51) Int. Cl. H01G 9/00

(52) U.S. Cl. 361/500

(57) ABSTRACT

An electrolytic capacitor comprising a casing with a cavity and a capacitor winding positioned inside the cavity, and a sealing element closing off the cavity. The electrolytic capacitor further comprises a reinforcement element having a major surface positioned substantially parallel to a major surface of the sealing element. This electrolytic capacitor has excellent properties, even when applied in high temperature soldering environments.

### FIELD OF THE INVENTION

The present invention relates to an electrolytic capacitor comprising a casing with a cavity and a capacitor winding positioned inside the cavity, and a sealing element closing off the cavity.

### PRIOR ART

International patent publication WO2009013943 discloses an electrolytic capacitor provided with a capacitor element; a bottomed case for storing the capacitor element; a sealing member for sealing the capacitor element at an open end portion of the bottomed case; and an anode lead line and a cathode lead line connected to an anode foil and a cathode foil through lead tabs.

### SUMMARY OF THE INVENTION

The present invention seeks to provide an electrolytic capacitor having improved properties in sustaining high temperatures, such as during high temperature extended time reflow soldering, e.g. needed for a lead-free reflow soldering connection of high quality.

According to the present invention, an electrolytic capacitor according to the preamble defined above is provided, further comprising a reinforcement element having a major surface positioned substantially parallel to a major surface of the sealing element.

As a result, no bulging of the sealing element can occur, eliminating one of the most important failure modes of electrolytic capacitors due to the soldering process.

### SHORT DESCRIPTION OF DRAWINGS

The present invention will be discussed in more detail below, using a number of exemplary embodiments, with reference to the attached drawings, in which

FIG. 1 shows a cross sectional view of an embodiment of an electrolytic capacitor according to the present invention;

FIG. 2 shows a cross sectional view of a combination of a sealing element and a reinforcement element as used in the embodiment shown in FIG. 1;

FIG. 3 shows a bottom view of an embodiment of an electrolytic capacitor according to the present invention.

### DETAILED DESCRIPTION OF EXEMPLARY EMBODIMENTS

Electrolytic capacitors are well known and widely used in a variety of electronics applications. Under certain conditions, e.g. conditions of high temperature extended time reflow soldering of an aluminum electrolytic capacitor, a failure mode of the electrolytic capacitor may result wherein bulging occurs due to excessive internal pressure. In the present invention embodiments, this kind of failure mode due to excessive heating of the electrolytic capacitor is prevented.

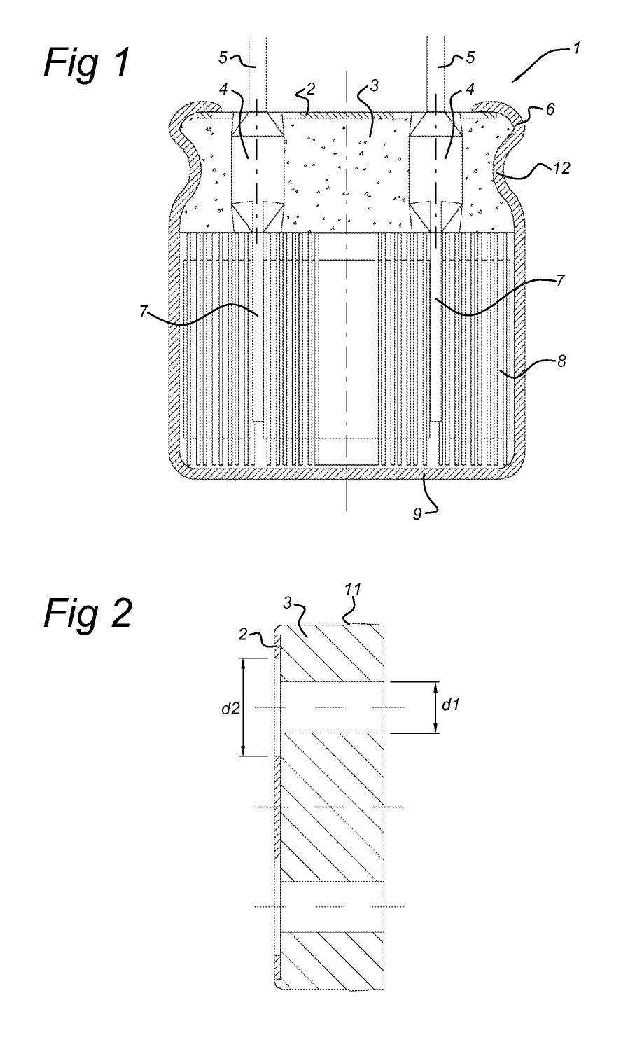

In FIG. 1 a cross sectional view is shown of an electrolytic capacitor 1 according to an embodiment of the present invention. The electrolytic capacitor 1 comprises a housing or case 6, which is e.g. made of a nylon clad aluminum material. A capacitor winding 8 is shown which comprises an anode foil (e.g. of etched and anodized aluminum with a high stability oxide), a spacer paper (e.g. impregnated with an electrolyte having a high boiling point), and a cathode foil (e.g. from etched and anodized aluminum), the winding impregnated with an electrolyte e.g. having a high boiling point as in many well known electrolytic capacitors.

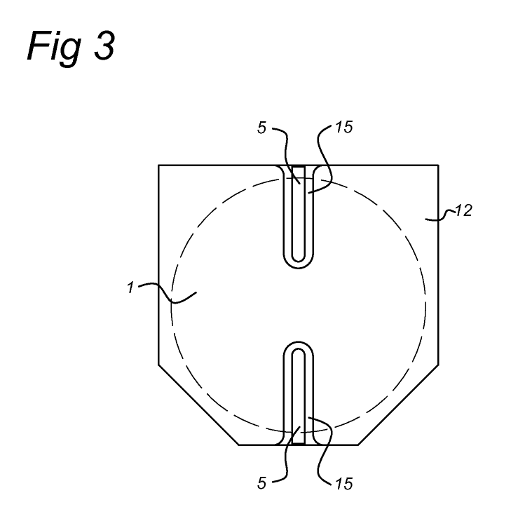

FIG. 3 shows a bottom view of an embodiment of the electrolytic capacitor 1 according to the present invention. In this embodiment, which is particularly suited for an SMD version of the electrolytic capacitor 1, a base plate 12 of temperature resistant material is provided flush with the terminal side of the electrolytic capacitor 1 (i.e. the top part of the embodiment as shown in FIG. 1). The base plate 12 is provided with terminal lead channels 15 for accommodating lead terminals 5 connected to the capacitor winding 8. It is noted that although the description is primarily addressing an SMD version of the capacitor 1, further embodiments may be provided for radial design capacitors 1, wherein the base plate 12 is not present, but which may be provided with similar features as the SMD version.

The electrolytic capacitor 1 further comprises a sealing element 3, held in the case 6 using a constriction 12. The sealing element 3 is e.g. made of a compressible and temperature resistant material, e.g. in the form of a rubber bung. The sealing element 3 is provided with two apertures in each of which a contact lead to one of the cathode and anode foils extends. Each contact lead comprises a connecting tab 4 (e.g. from aluminum) positioned in the aperture. The connecting tab 4 provides for the connections between two flattened electrode connections 7 (which are attached to the cathode and anode foils of the capacitor winding 8) and the externally positioned terminals 5 (e.g. made from steel).

In the embodiment shown, the sealing element 3 is provided with a reinforcement element 2, in this embodiment in the form of a disc shaped metal inlay on the outside surface of the sealing element 3. In FIG. 2 a cross sectional view is shown of the combination of sealing element 3 and reinforcement element 2, i.e. before assembly in the casing 6 using a constriction 12 deforming the sealing element 3. As shown in this embodiment, the reinforcement element 2 is provided with lead apertures having a diameter d2. The lead apertures have a diameter d2 greater than or equal to a diameter d1 of corresponding apertures in the sealing element 3. A diameter d2 larger than the diameter d1 allows to use e.g. a metal reinforcement element 2 without any risk of the terminals 5 of the electrolytic capacitor 1 coming into contact with the reinforcement element 2.

The reinforcement element 2 in one particular embodiment is a disc shaped metal plate. Using a metal as material for the reinforcement element 2 allows to use a moderate thickness (e.g. of at least 0.1 mm, in one exemplary embodiment the thickness is typical 0.4 mm or e.g. 0.25 mm), thus not adding too much weight and still providing sufficient strengthening.

The reinforcement element 2 may be positioned as inlay in a space provided in the sealing element 3. In a further embodiment, the reinforcement element 2 is already added as inlay when manufacturing the sealing element 3, e.g. using a molding process. As further alternatives, the reinforcement element 2 may be attached to the sealing element 3 using an adhesive or the like.

In the embodiment shown in FIG. 2, the sealing element 3 is also provided with a small rim 11. This rim 11 is helpful e.g. in retaining the sealing element 3 in the correct position in the casing 6 during assembly, i.e. before applying the constriction 12.

The reinforcement element 2 may be provided in contact with a rim of the casing 6 in a further embodiment, as shown clearly in the cross sectional view of FIG. 1. This would even allow to assemble the capacitor 1 without affixing the reinforcement element 2 to the sealing element 3.

In the embodiment shown, the casing bottom 9 is furthermore provided with a rim pattern, e.g. in the form of an X pattern, which provides additional strength to the casing bottom 9 while minimizing material use. In further embodiments other types of patterns may be used, such as a honeycomb rim pattern or diamond shaped rim pattern. In general terms, the present invention embodiments relate to an electrolytic capacitor 1 comprising a casing 6 with a cavity and a capacitor winding 8 positioned inside the cavity, and a sealing element 3 closing off the cavity. The electrolytic capacitor 1 further comprises a reinforcement element 2 having a major surface positioned substantially parallel (or co-planar) to a major surface of the sealing element 3.

In a further embodiment the reinforcement element 2 is positioned adjacent a surface of the sealing element 3 remote from the cavity of the casing 6. The capacitor winding 8 is positioned in the cavity of the casing, i.e. adjacent a surface of the sealing element 3 nearest to the cavity of the casing 6. In other words, the reinforcement element 2 is positioned adjacent the sealing element 3, at the opposite side of the sealing element 3 from where the capacitor winding 8 is positioned.

In the state of the art capacitors, excessive heating (which may occur during high temperature extended time reflow soldering, e.g. when positioning and connecting an SMD capacitor on a PCB) results in an excessive bulging of the rubber bung 3. This may cause deformation of the internal capacitor winding 8 by the outward force exerted on the leads (and thus electrode connections 7). Deformation of the base plate 12 may also occur, which results in a deterioration of the co-planarity of the externally positioned terminals 5, resulting in problems when trying to make a well soldered connection for a SMD embodiment of the electrolytic capacitor. These problems are prevented by including the reinforcement element 2. This is the case when applying reflow soldering using IR heat, which is usually applied from the top side of the capacitor 1 on the PCB. The problems are also prevented when applying vapor phase soldering to the capacitor 1 with base plate 12, leads 5 and inlay 2.

In a further embodiment the casing 6 is glued to the base plate 12 at a minimum number of points along the circumference, further preventing a deteriorated co-planarity of the externally positioned terminals 5 due to the excessive bulging of the rubber bung 3 by fixing the base plate 12. Additionally, the life time of the electrolytic capacitor 1 is increased as the escape rate of the electrolyte solvent vapor is reduced as well.

The present invention embodiments have been described above with reference to a number of exemplary embodiments as shown in the drawings. Modifications and alternative implementations of some parts or elements are possible, and are included in the scope of protection as defined in the appended claims.

1. An electrolytic capacitor comprising
a casing with a cavity and a capacitor winding positioned inside the cavity, and a sealing element closing off the cavity,
further comprising a reinforcement element having a major surface positioned substantially parallel to a major surface of the sealing element.

2. The electrolytic capacitor of claim 1, further comprising a base plate of temperature resistant material.

3. The electrolytic capacitor of claim 2, wherein the base plate is provided with terminal lead channels for accommodating leads connected to the capacitor winding.

4. The electrolytic capacitor of claim 2, wherein the casing and the base plate are attached to each other using a glue material.

5. The electrolytic capacitor of claim 1, wherein the reinforcement element is positioned adjacent a surface of the sealing element remote from the cavity.

6. The electrolytic capacitor of claim 1, wherein the reinforcement element comprises a metal element.

7. The electrolytic capacitor of claim 1, wherein the reinforcement element is positioned in contact with the casing.

8. The electrolytic capacitor of claim 1, wherein the reinforcement element is provided with lead apertures.

9. The electrolytic capacitor of claim 8, wherein the lead apertures have a diameter greater than or equal to a diameter of corresponding apertures in the sealing element.

10. The electrolytic capacitor of claim 1, wherein a thickness of the reinforcement element is at least 0.1 mm.

11. The electrolytic capacitor of claim 1, wherein the casing bottom is provided with a rim pattern.
